(19) United States
(12) Patent Application Publication
(10) Pub. No.: US 2021/0224871 A1
(43) Pub. Date: Jul. 22, 2021

(54) TRANSACTION DATA INSIGHTS FOR REVIEW PLATFORMS AND MERCHANT APPLICATIONS

(71) Applicant: MASTERCARD INTERNATIONAL INCORPORATED, Purchase, NY (US)

(72) Inventors: Sunil MISHRA, Vadodara (IN); Parth VEDANT, Bhuj (IN); Apurva SHAH, Vadodara (IN); Riddhi PATEL, Vadodara (IN); Darshan SHAH, Vadodara (IN)

(21) Appl. No.: 16/745,192

(22) Filed: Jan. 16, 2020

(51) Int. Cl. G06Q 30/02

(52) U.S. Cl. CPC G06Q 30/0282; G06Q 30/0202

(57) ABSTRACT

Insights about customers and/or merchants obtained through analysis of transaction data between the customers and the merchants can be provided to a review platform, merchants, or even customers themselves. A method can include receiving transaction data, the transaction data comprising at least two transaction attributes; segmenting the transaction data based on a particular insight option of a plurality of insight options; and determining a resulting insight for the particular insight option based on the segmented transaction data. The transaction data can include attributes such as a merchant identifier, a masked user identifier, a time and date, a payment method, a country code of an issuer, a country code of the merchant, a state code of the merchant, a city code of the merchant, or a category code of the merchant.

### BACKGROUND

Customers use review platforms to decide where to take their business for goods and/or services. Review platforms may be accessed, for example, through websites or in applications that are downloaded to devices. Non-limiting examples of review platforms include Google (with Google Reviews and Google My Business), Yelp, Amazon, and TripAdvisor. When a new customer uses or buys the goods and/or services, they can leave a review on the review platform for that merchant. In some cases, review platforms allow customers to leave reviews of a merchant without any proof that the reviewer ever visited the merchant. Furthermore, not all customers leave reviews on the merchants they visit; some customers only leave reviews when they have an exceptionally good or exceptionally bad experience, which can skew the results of the review platforms. In some cases, a customer may only leave one review despite visiting the merchant many times (and may have many different satisfaction levels between each experience). Therefore, a customer who patronizes a merchant once may have the same amount of influence for that merchant on a review platform as a customer who patronizes that merchant many times.

Transaction data, including single message (e.g., debit card) and dual message (e.g., credit card) transactions, may identify the merchant and the customers who visit that merchant. This transaction data may be collected by the merchant itself (for transactions occurring at that specific merchant), the issuer of the card, or a financial services company (e.g., Mastercard Inc.).

### BRIEF SUMMARY

Providing insights about customers and/or merchants obtained through analysis of transaction data between the customers and the merchants are described herein. Insights refer to information that is useful to review platforms, customers, merchants, card issuers, and/or financial services companies. When used by customers, insights provide enhanced information to help the customers decide which merchant to use; when used by merchants, card issuers, and/or financial services companies, insights provide enhanced information that can be used to provide better customer service and/or better goods and/or services; when used by review platforms, enhanced information about merchants can be provided to customers. The enhanced information may also help improve the current information the review platforms provide by potentially adding extra weighting to the reviews of repeat customers or removing customers who cannot be verified to have ever patronized a merchant, such as fake reviews (e.g., reviews added by friends and family of an actual customer, reviews added by bots, paid reviews, and/or negative reviews added by competitors of the merchant). In some cases, the system can mark reviews as fake or genuine based on whether the customer is verified as having patronized the merchant.

A system is provided that includes an analysis engine that determines insights from transaction data. The system can be configured to manage and provide access to the insights determined by the analysis engine from the transaction data. The transaction data can be obtained from systems that process payment transactions, including single message systems, dual message systems, and electronic payment wallet application systems. The analysis engine can segment the transaction data based on a particular insight option of a plurality of insight options, determine a resulting insight for the segmented transaction data, and store the resulting insight in a storage resource associated with the system. The system can provide access to the information stored in the storage resource via push or pull communications.

In some cases, the system includes a storage resource for storing insights, an analysis engine operably coupled to a transaction resource and configured to: receive transaction data, the transaction data comprising at least two transaction attributes; segment the transaction data based on a particular insight option of a plurality of insight options; determine a resulting insight for the particular insight option based on the segmented transaction data; and an insight access module configured to manage and provide access to the insights stored in the storage resource, the insight access module supporting an insights application programming interface (API) or a push service.

For pull communication-based access, a method of providing insights includes receiving a request to access a particular type of insight via an insights API; and, in response to the request, obtaining corresponding insights for the particular type of insight from the storage resource and sending the corresponding insights for the particular type of insight to a source of the request. For push communication-based access, a method of providing insights can include identifying one or more recipients of a particular type of insight; and sending, to each identified recipient of the one or more recipients, corresponding insights for the particular type of insight. In some cases, the recipients are registered subscribers for an insights service. In some cases, the recipients are merchants.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example environment for transaction data insights.

FIG. 2 conceptually illustrates different types of analyses performed by an analysis engine to provide particular insight options.

FIGS. 3A and 3B illustrate example processes that may be carried out by an Insights system.

FIG. 4 illustrates example requests to an insights application programming interface (API).

FIG. 5 illustrates an example of transaction data that has been segmented for a specific merchant and used to identify new/returning customers.

FIG. 6A illustrates an example user interface of a review platform that has implemented insights based on transaction data for restaurants.

FIG. 6B illustrates an example user interface of a review platform that has implemented insights based on transaction data for lodging rentals.

FIG. 7 illustrates components of a computing system that may be used in certain embodiments described herein.

FIG. 8 illustrates a simplified block diagram of a user device that may be used to generate user interfaces.

### DETAILED DESCRIPTION

Providing insights about customers and/or merchants obtained through analysis of transaction data between the customers and the merchants are described herein. Insights refer to information that is useful to review platforms, customers, merchants, card issuers, and/or financial services companies. When used by customers, insights provide enhanced information to help the customers decide which merchant to use; when used by merchants, card issuers, and/or financial services companies, insights provide enhanced information that can be used to provide better customer service and/or better goods and/or services; when used by review platforms, enhanced information about merchants can be provided to customers. The enhanced information may also help improve the current information the review platforms provide by potentially adding extra weighting to the reviews of repeat customers or removing customers who cannot be verified to have ever patronized a merchant, such as fake reviews (e.g., reviews added by friends and family of an actual customer, reviews added by bots, paid reviews, and/or negative reviews added by competitors of the merchant).

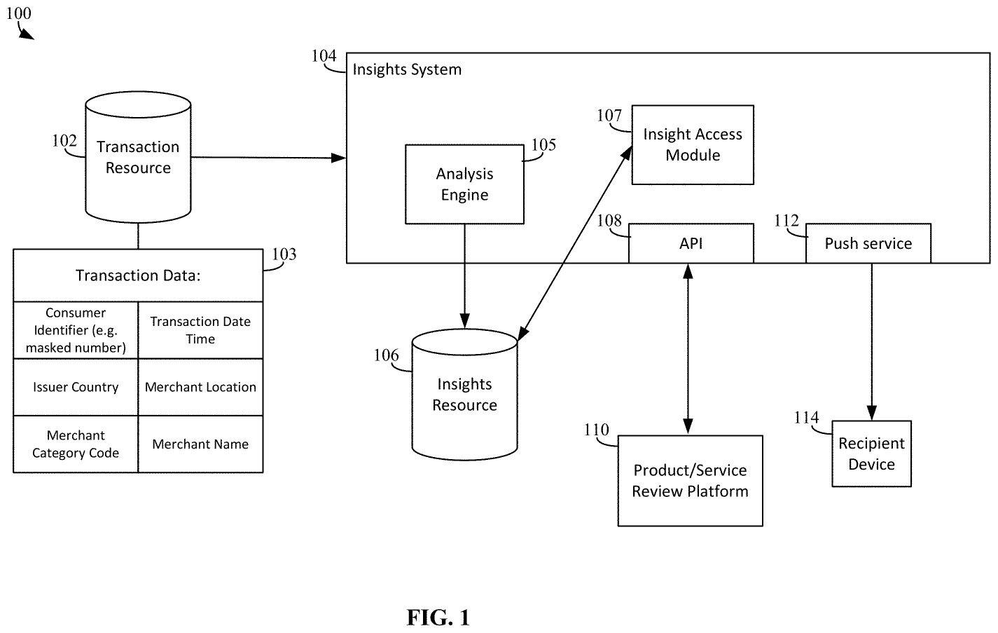

FIG. 1 illustrates an example environment for transaction data insights. Referring to FIG. 1, environment 100 includes a transaction resource 102 that can store transaction data 103; and an insights system 104 that includes an analysis engine 105 that determines insights, which can be stored in an insights resource 106, and an insight access module 107.

Transaction data 103 includes, at a minimum, at least two transaction attributes. Transaction attributes of the transaction data 103 can include, but are not limited to, a merchant identifier (e.g., a merchant's name or other identifying information), a masked user identifier (e.g., a masked card number or other value or string used to distinguish between users but not reveal actual user information), a value (e.g., an amount of money), currency, a payment method (e.g., particular card product such as Mastercard, Visa, American Express, payment type such as credit, debit, pre-paid), a time and date, and the goods and/or services being sold in exchange for the value, as well as other information. In some cases, the transaction attributes are any transaction attributes available according to one or more standards (e.g., ISO). It should be understood that any transaction data stored or accessed by the system 104 is maintained according to appropriate privacy policies and laws, and would not include personal or financial information of customers except that which is permitted (for example by opt-in processes). The transaction data 103 can be obtained from systems that process payment transactions, including single message systems, dual message systems, and electronic payment wallet application systems. Some transaction data 103, such as the goods and/or services being sold, can be obtained from an acquirer or issuer when not directly available from the fields in a transaction data message.

The analysis engine can perform one or more analyses on the transaction data 103 in order to generate insights. Each insight option is an “insight” into how users are using the goods and/or services of a merchant that is gleaned from the transaction data 103. An insight option can, in its simplest form, be directed to a relationship between any two attributes selected from the available attributes of the transaction data (and even attributes derived from the attributes of the transaction data, such as a ratio of two attributes or aggregations of attributes, such as an average cost of purchases from a merchant).

Examples insight options include, but are not limited to 1) how many and/or what percentage of customers are returning customers for a particular merchant, 2) how many and/or what percentage of customers are new customers for a particular merchant, 3) a particular community of customers (e.g., customers of a specific nationality or from a particular geographic location—referred to herein as a “location-based community of customers”), 4) payment methods a merchant accepts or a user uses, and 5) an operational status of a merchant. Insight options can also be for particular groups, for example, based on location, industry, merchant category, and the like. More complex insight options can also be available, such as whether a merchant is popular with tourists or locals, which may be identified by a combination of customer origin or path of spend and how often or the number of visits to a particular merchant.

In some cases, a plurality of insight options is predefined by the system 104. In some cases, users of the system 104 can select which insight options are used by the analysis engine 105. The analysis engine may continually generate insights according to the insight options, for example, updating after a certain period of time, upon receiving additional transaction data, in response to requests or other triggers, or in a continuous manner (e.g., where the next analysis is performed as soon as a current analysis is complete). Insights generated by the system 104 can be stored in the insights resource 106.

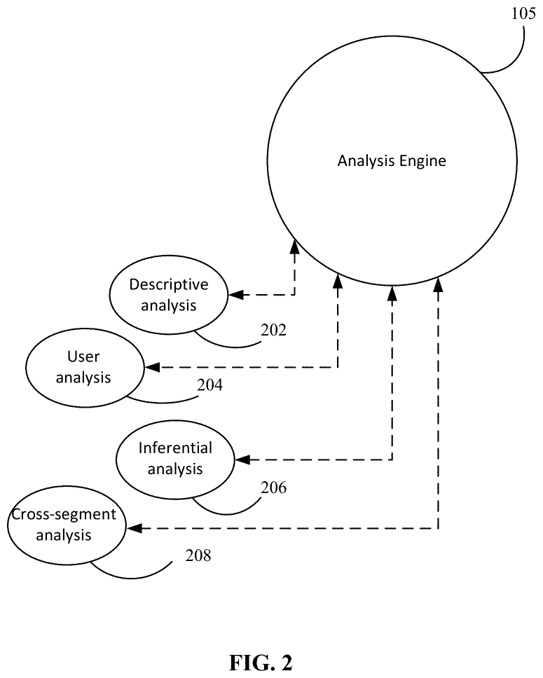

FIG. 2 conceptually illustrates different types of analyses performed by an analysis engine to provide particular insight options. Referring to FIG. 2, the analysis engine 105 can perform descriptive analysis 202, user analysis 204, inferential analysis 206, and/or cross-segment analysis 208.

Descriptive analysis 202 refers to measures of frequency (e.g., count, percent, frequency), measures of central tendency (e.g., mean, median, mode), measures of dispersion or variation (e.g., range, standard deviations), and measures of position (e.g., ranking). The descriptive analysis 202 can be univariate (e.g., for an individual variable—in this case an individual transaction attribute), bivariate (e.g., including a relationship between two different variables), or multivariate (e.g., including a relationship between two or more variables). An example of descriptive analysis is determining how many customers of a particular restaurant are returning customers.

User analysis 204, as used herein, refers to the evaluation of behavior or characteristics of a particular user or group of users with respect to transactions. An example of user analysis determining the proportional amount of currency a particular user or type of user (since personal identifying information may not be available) spends in each industry category. Insights from user analysis 204 may be used to target content to a particular user (when permitted by the user). For example, if a particular user or category of user is identified as spending a relatively high proportion of currency on dining and travel, a special promotional package can be offered for a dining and travel combination from an interested entity (e.g., card issuer, financial services company, or even a dining and/or travel merchant themselves).

Inferential analysis 206 refers to processes for identifying inferences, or predictions, based on the data. Inferential analysis 206 includes linear regression analysis (as well as bi-variate regression and multi-variate regression), T-Tests (statistical significance), Chi-Squared, variance analysis (ANOVA), co-variance analysis, and correlation analysis. An example of an inferential analysis is determining whether a restaurant is popular among locals or tourists. This may be inferred based on data indication proportion of customers determined to likely reside near the restaurant to the proportion of customers determined to likely be from a different region based on transaction data.

Cross-segment analysis 208 refers to inferences that can be made across different segments (e.g., different industries or groups). Cross-segment analysis 210 can be used to bolster existing analysis of transaction data as well as be used to provide insights to merchants, card issuers, and/or financial services companies. Continuing with the above example of using inferential analysis 206, an inference that a particular restaurant is popular among tourists can be used to provide/suggest partnerships between different types of merchants by looking at segmented transaction data from industries other than dining, such as that a high proportion of that particular restaurant's customers also rent a hotel room on the same night they dine at that particular restaurant. For example, a merchant hotel can be provided with information that a relatively high proportion of hotel customers also dine at the particular restaurant, and therefore it may be beneficial for the merchant hotel to partner with the particular restaurant to offer a dining package at the particular restaurant when customers book a hotel room in order to capture a larger market share of hotel customers in that area.

Returning to FIG. 1, in addition to an analysis engine 105, system 104 can include an insight access module 107 (which may be software and/or hardware). Insight access module 107 can manage and provide access to the insights determined by the analysis engine 105 from the transaction data 103 (and stored in insights resource 106).

The system 104 can provide access to the information (e.g., insights) stored in the insights resource 106 via push or pull communications. For example, access to insights (e.g., as a pull communication) can be made available via an insights application programming interface (API) 108.

An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational State Transfer) or SOAP (Simple Object Access Protocol) architecture.

Insights API 108 can include one or more APIs for requesting specific insights stored in the Insights resource 106. The system 104 can receive a request to access a particular type of insight via the insights API 108; and, in response to the request, obtain corresponding insights for the particular type of insight from the insights resource 106 and send the corresponding insights for the particular type of insight to the source of the request.

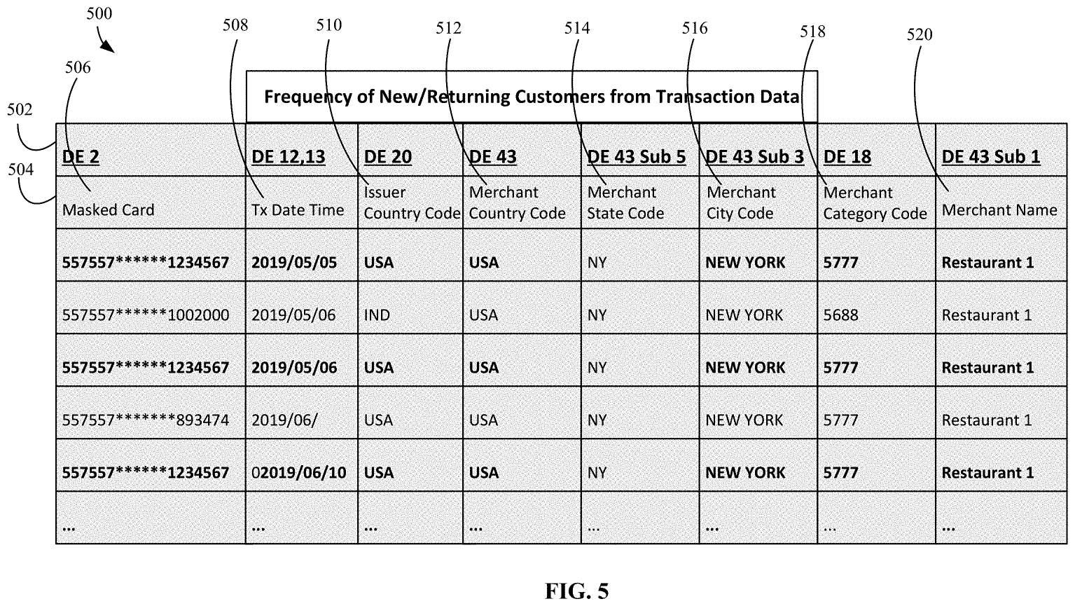

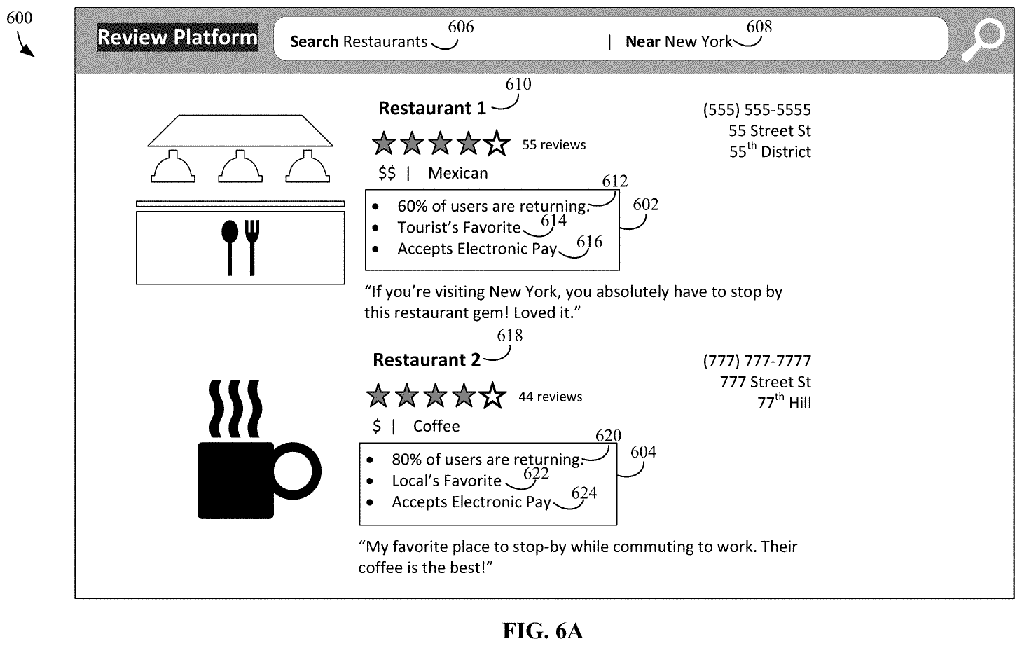

A product/service review platform 110 can obtain insights via the insights API 108. The product/service review platform 110 may communicate with Insights system 104 to obtain the insights in response to a user of the product/service review platform 110 viewing one or more particular merchants (see e.g., FIGS. 6A and 6B) or may communicate with Insights system 104 to obtain insights at some predetermined interval or pattern such that the insights can be used in any suitable manner by the product/service review platform 110.

In some cases, the system 104 can include a push service 112. The system 104 can identify one or more recipients of a particular type of insight; and send, to each identified recipient of the one or more recipients, corresponding insights for the particular type of insight via the push service 112. In some cases, the recipients are registered subscribers for the insights service 112 (subscriber resource and registration not shown). In some cases, the recipients are merchants. The insight access module 107 may support the push service 112 by identifying the corresponding insights from the insights resource 106.

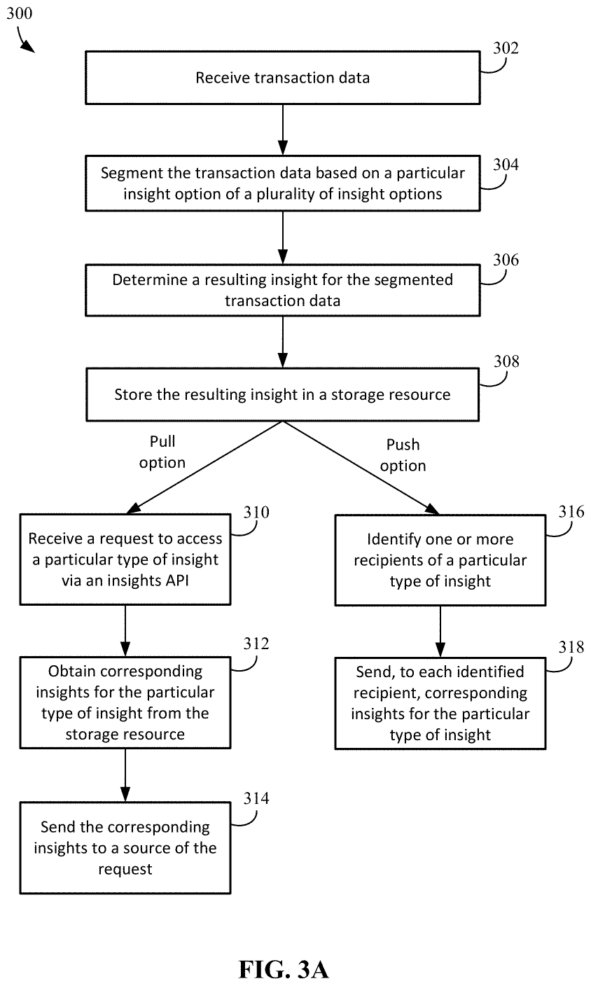

FIGS. 3A and 3B illustrate example processes that may be carried out by an Insights system. Processes 300 and 320 may be carried out by system 104.

Referring to FIG. 3A, the process 300 includes receiving (302) transaction data; segmenting (304) the transaction data based on a particular insight option of a plurality of insight options; and determining (306) a resulting insight for the segmented transaction data. Operations 302, 304, and 306 may be performed by insights system 104. For example, the insights system 104 receives the transaction data 103 from the transaction resource 102 and, via the analysis engine 105, segments the transaction data 103 based on a particular insight option.

The segmenting (304) can be performed by the analysis engine 105 according to any suitable technique such as objective (supervised) and non-objective (unsupervised) segmentation methodologies, including, but not limited to, chi square automatic interaction detector (CHAID), classification and regression tree (CRT)/Gini impurity, cluster analysis, and K nearest neighbor.

In various implementations, segmentation can be based on the transaction data 103 that is associated with a particular merchant, category of merchants (e.g., travel, dining), or grouping of merchants (e.g., region, listed on a reviewer platform).

The determining (306) of the resulting insight can be performed by the analysis engine 105 based on the segmented transaction data. For example, if the particular insight option is what percentage of customers are returning customers for a particular merchant, the resulting insight would be the actual percentage of customers who have returned to that particular restaurant (e.g., 60%).

As mentioned above, the resulting insight can be a specific piece of information and/or inference that is gleaned from the transaction data. The resulting insight is the actual result of the of the analysis (e.g., inferential analysis, cross-segment analysis, descriptive analysis, or user analysis). For example, if the particular insight option is a percentage of returning customers, the resulting insight is the actual percentage of returning customers (e.g., 80%).

The process 300 can further include storing (308) the resulting insight in a storage resource, which is then available upon request.

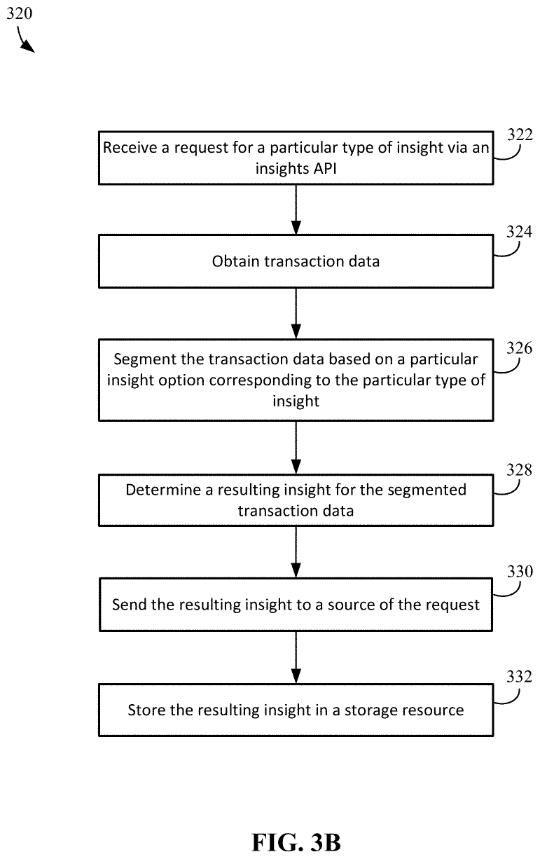

For pull communication scenarios, process 300 includes receiving (310) a request to access a particular type of insight via an insights API, such as API 108 of FIG. 1; obtaining (312) corresponding insights for the particular type of insight from the storage resource; and sending (314) the corresponding insights to a source of the request. Examples of a set of requests to the insights API are illustrated in FIG. 4.

FIG. 4 illustrates example requests to an insights API. Referring to FIG. 4, a request from a source, such as product/service review platform 400, to an insights API 410, which may be embodied as described with respect to API 108 of FIG. 1, can include a type of insight and one or more parameters. In the examples shown in FIG. 4, the product/service review platform 400 is making individual calls to the insights API 410. In some cases, a call can contain multiple insight types instead of the individual insight requests illustrated in the example of FIG. 4. It should also be understood that the particular names for the insights and parameters presented herein are for illustrative purposes and are not intended to reflect all implementations of the described APIs.

In the illustrated example, a product/service review platform 400 is sending a plurality of requests to the insights API 410. Here, a first request 412 is for a repeat customer 414 type of insight and the parameters sent to the insights API 410 include a merchant identifier 416 indicating the merchant of interest and an indication that the result is desired as a percentage value 418. In response to the first request 412, the insights API 410 returns the insight 420 of a repeat customer percentage for the requested merchant. A second request 430 is for a tourist-or-local 432 type of insight and the parameters sent to the insights API 410 include a merchant identifier 434 indicating the merchant of interest. In response to the second request 430, the insights API 410 returns the insight 436 of whether the requested merchant is popular with tourists or with locals.

A third request 440 is for an accepted payments 442 type of insight and the parameters sent to the insights API 410 include a merchant identifier 444 indicating the merchant of interest. In response to the third request 440, the insights API 410 returns the insight 446 of the types of accepted payments for the requested merchant. A fourth request 450 is for a popular-customer-region 452 type of insight and the parameters sent to the insights API 410 include a merchant identifier 454 indicating the merchant of interest. In response to the fourth request 450, the insights API 410 returns the insight 456 of the region(s) that customers of the requested merchant appear to be popular (e.g., a number of customers above a threshold are from India and Brazil or are from other identifiable regions smaller than a country).

A fifth request 460 is for an operational status 462 type of insight and the parameters sent to the insights API 410 include a merchant identifier 464 indicating the merchant of interest. In response to the fifth request 460, the insights API 410 returns the insight 466 of whether the requested merchant is in operation (e.g., whether there has been activity at this merchant, including in some cases whether merchant is in peak season or in off season based on the number of transactions, or that the merchant is actually no longer in operation).

Returning to FIG. 3A, for push communication scenarios, process 300 includes identifying (316) one or more recipients of a particular type of insight; and sending (318), to each identified recipient, corresponding insights for the particular type of insight.

Referring to FIG. 3B, the process 320 includes receiving (322) a request for a particular type of insight via an insights API, such as via API 108 of FIG. 1. In the process 320, the particular type of insight may not have been generated yet, may be expired/old information in the storage resource, is waiting for the trigger of the API call in order to identify which transaction data to use, or there is some other reason why process 320 is performed. In response to the request, process 320 can obtain (324) transaction data; segment (326) the transaction data based on a particular insight option corresponding to the particular type of insight; and determine (328) a resulting insight for the segmented transaction data similarly to that described with respect to operations 302, 304, and 306 but with the particular insight option identified from the request received in operation 322. Once the resulting insight is determined, the resulting insight can be sent (330) to a source of the request.

In some cases, the resulting insight is stored (332) in a storage resource. In some of such cases, the resulting insight can be later retrieved again or pushed out to other potential recipients without updating the insight with new transaction data (for example if there is no new transaction data).

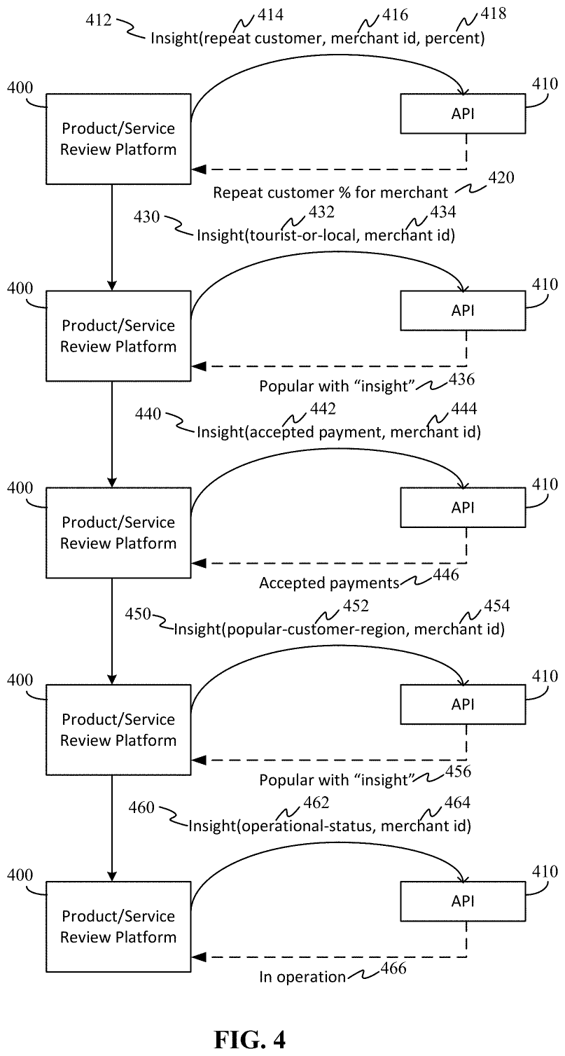

FIG. 5 illustrates an example of transaction data that has been segmented for a specific merchant and used to determine frequency of new/returning customers. Referring to FIG. 5, a table of segmented transaction data 500 is shown. Here, transaction codes are shown in row 502 and the corresponding transaction fields are shown in row 504. Each row denotes a single transaction with the columns indicating a masked card number 506, a transaction date 508, a country code for an issuer of the card account 510, a country code for the specific merchant 512, a state code for the specific merchant 514, a city code for the specific merchant 516, a category code for the specific merchant 518, and a name of the merchant 520.

The masked account number 506 can act as an identifier for a particular user. The transaction date 508 denotes the date the transaction occurred. In some cases, the transaction date may also include a time (e.g., hours, minutes, seconds) for that date. The country code for the issuer of the card account 510 denotes an identifier for the country from which the company (e.g., bank) that issued the account is located. The country code for the specific merchant 512 denotes an identifier for the country from which the specific merchant (that the customer bought goods and/or services from) is located. The state code for the specific merchant 514 denotes an identifier for the state (if applicable) from which the specific merchant (that the customer bought goods and/or services from) is located. The city code for the specific merchant 516 denotes an identifier for the city from which the specific merchant (that the customer bought goods and/or services from) is located. The category code for the specific merchant 518 denotes the category of goods and/or services (e.g., dining or clothing) that is being sold in that transaction by the merchant to the customer. As can be seen, the merchant category code 518 may be different although the name of the merchant 520 is the same because the goods and/or services being sold are different, but the merchant is the same.

As can be seen, because the segmented transaction data 500 has been segmented for the particular insight option of frequency of new/returning customers for a particular merchant, data corresponding to the particular merchant (Restaurant 1) is available for analysis. The segmented data can be analyzed by an analysis engine, such as described with respect to analysis engine 105, that performs a descriptive analysis 202 to determine frequency of new/returning customers.

For example, in order to determine the percentage of new/returning customers, a customer (e.g., identified by the masked account number 506) can be classified as a returning customer if that customer has made more than one transaction at different times with the same merchant. Conversely, a customer can be classified as a new customer if that customer has only made one transaction at a single time with the same merchant during the time period covered by the segment of transaction data 500. The percentage of new or returning customers can then be determined by dividing the number of new or returning customers by the total number of customers that have bought goods and/or services with that merchant. In some cases, a time element may be implemented on new and returning customers such that customers may be considered “new” if they haven't been to the merchant after a certain period of time (e.g., one year).

FIG. 6A illustrates an example user interface of a review platform that has implemented insights based on transaction data for restaurants. In the scenario illustrated in FIG. 6A, the user interface 600 illustrates results 602, 604 for a search input 606 of restaurants with a location 608 of “Near New York” on a review platform. The review platform can, in response to receiving a search request (e.g., via search input 606) from a user and identifying corresponding results, communicate with an insights system to request insights for the merchants identified in the corresponding results. The requested insights may be obtained using calls similar to 412, 430, and 440 described with respect to FIG. 4. As can be seen, the first result 602 of the search 606 is for Restaurant 1 610 and includes three resulting insights. The first resulting insight 612 is a percentage of customers who are returning (60%), the second resulting insight 614 is a remark that Restaurant 1 608 is a tourist's favorite, and the third resulting insight 616 is that electronic-pay is accepted by Restaurant 1 610.

The second result 604 of the search 606 is for Restaurant 2 618 and includes three resulting insights. The first resulting insight 620 is a percentage of customers who are returning (80%), the second resulting insight 622 is a remark that Restaurant 2 618 is a local's favorite, and the third resulting insight 624 is that electronic-pay is accepted by Restaurant 2 618.

In some cases, the types of electronic payment (e.g., Google Pay, Apple Pay) may also be listed as a resulting insight. Of course, more or fewer insights can be obtained and displayed by the review platform.

FIG. 6B illustrates an example user interface of a review platform that has implemented insights based on transaction data for lodging rentals. In the scenario illustrated in FIG. 6B, the user interface 630 illustrates results 632, 634 for a search input 636 of homes with a location 638 of “Near New York” on a review platform. The review platform can, in response to receiving a search request (e.g., via search input 636) from a user and identifying corresponding results, communicate with an insights system to request insights for the merchants identified in the corresponding results. The requested insights may be obtained using calls similar to 450 and 430 described with respect to FIG. 4. As can be seen, the first result 632 of the search 636 is for Cozy Room 640 and includes two resulting insights. The first resulting insight 642 is a remark that Cozy Room 640 is popular among people from X region and the second resulting insight 644 is a remark that Cozy Room 640 is a local's favorite.

The second result 634 of the search 636 is for Your Home Away From Home 646 and includes two resulting insights. The first resulting insight 648 is a remark that Your Home Away From Home 646 is popular among people from Y and Z regions. The second resulting insight 650 is a remark that Your Home Away From Home 646 is a tourist's favorite.

Of course, more or fewer insights can be obtained and displayed by the review platform.

It should be understood that the examples of resulting insights in FIGS. 6A and 6B are merely examples, and more or fewer resulting insights may be included depending on the review platform user interface, preferences of the user, as well as other considerations.

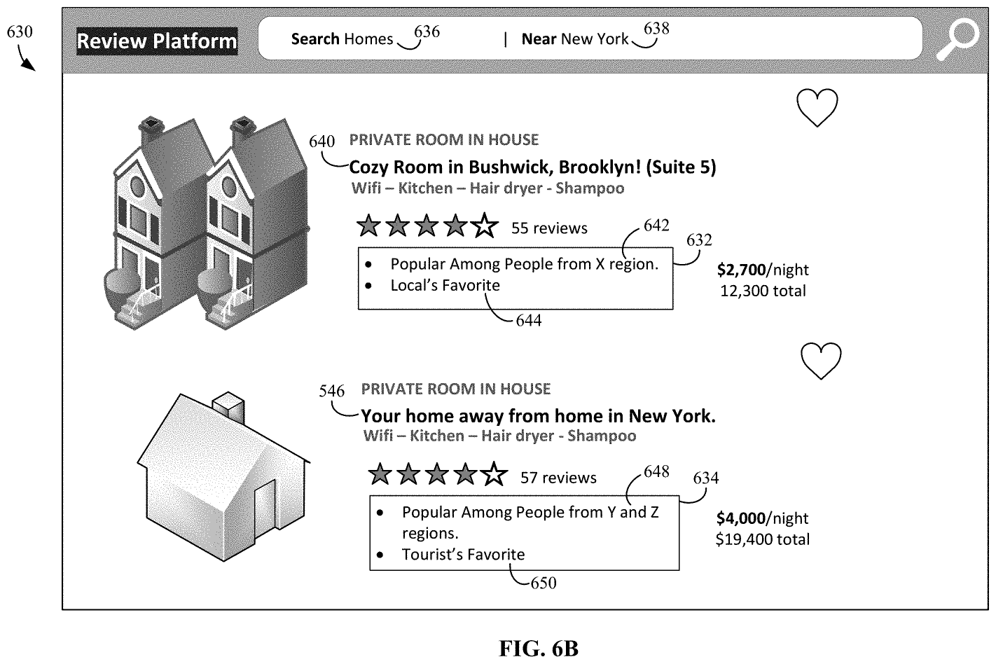

FIG. 7 illustrates components of a computing system that may be used in certain embodiments described herein.

Referring to FIG. 7, system 700 may be implemented within a single computing device or distributed across multiple computing devices or sub-systems that cooperate in executing program instructions. The system 700 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 700 can include a processing system 710, which may include one or more processors and/or other circuitry that retrieves and executes software 720 from storage system 730. Processing system 710 may be implemented within a single processing device but may also be distributed across multiple processing devices or sub-systems that cooperate in executing program instructions.

Storage system(s) 730 can include any computer readable storage media readable by processing system 710 and capable of storing software 720. Storage system 730 may be implemented as a single storage device but may also be implemented across multiple storage devices or sub-systems co-located or distributed relative to each other. Storage system 730 may include additional elements, such as a controller, capable of communicating with processing system 710. Storage system 730 may also include storage devices and/or sub-systems on which data is stored. System 700 may access one or more storage resources such as insights resource 732 and transactions resource 734, in order to access information to carry out any of the processes indicated by software 720.

Software 720, including routines for performing processes such as processes 300, 320 for determining and providing insights to third parties may be implemented in program instructions and among other functions may, when executed by system 700 in general or processing system 710 in particular, direct the system 700 or processing system 710 to operate as described herein.

In embodiments where the system 700 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 740 may be included, providing communication connections and devices that allow for communication between system 700 and other computing systems (not shown) over a communication network or collection of networks (not shown) or the air.

In some embodiments, system 700 may host one or more virtual machines.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

It should be understood that as used herein, in no case do the terms “storage media,” “computer-readable storage media” or “computer-readable storage medium” consist of transitory carrier waves or propagating signals. Instead, “storage” media refers to non-transitory media.

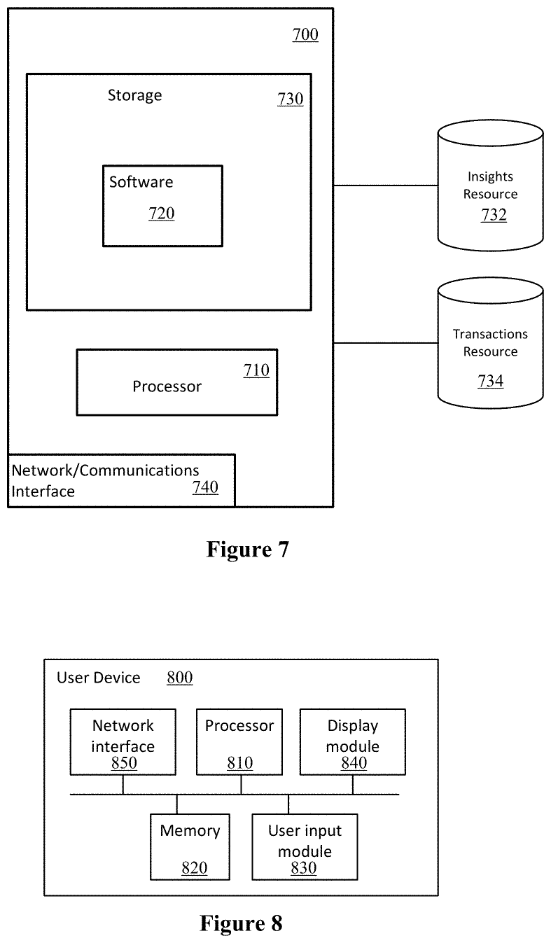

FIG. 8 illustrates a simplified block diagram of a user device that may communicate with an insights system. User device 800 can be used to generate user interfaces, such as user interfaces 600, 630 of FIGS. 6A and 6B. User device 800 can be any suitable computing device and can be embodied as a mobile phone, smart watch, laptop, tablet, desktop, or other computing device. User device 800 can include a processor 810, memory 820, user input module 830, display module 840, and network interface 850. Of course, more or fewer elements described with respect to device 800 may be incorporated to implement a particular computing device.

Processor 810 can include one or more processors to transform or manipulate data according to the instructions of software stored in the memory 820. Examples of processor 810 include general purpose central processing units, application specific processors, and logic devices, as well as any other type of processing device, combinations, or variations thereof.

Memory 820 may comprise any computer readable storage media readable by the processor 810 and capable of storing software such as a review platform application (e.g., as a mobile app), a web browser application, merchant applications, and wallet applications. Memory 820 can include removable and non-removable memories and can include random access memory, read only memory, magnetic disks, optical disks, CDs, DVDs, flash memory, magnetic cassettes, magnetic tape, magnetic disk storage or other magnetic storage devices, or any other suitable storage media as examples.

The user input module 830 receives and interprets user input, such as input from a microphone, from a touch screen display, from a camera, and from buttons or keys on the device, to provide resulting information to appropriate modules or applications such as a review platform web page via a web browser (e.g., illustrated in user interfaces 600, 630 of FIGS. 6A and 6B).

Display module 840 supports the rendering and display of content and application graphical user interfaces, such as graphical interfaces and content for providing and illustrating resulting insights. Examples of interfaces are shown in FIGS. 6A and 6B.

Network interface 850 provides communication connections and devices that allow for user device 800 to communicate over a communication network or collection of networks, or the air with other computing devices and systems.

Embodiments may be implemented as a computer process, a computing system, or as an article of manufacture, such as a computer program product or computer-readable medium. Certain methods and processes described herein can be embodied as software, code and/or data, which may be stored on one or more storage media that when executed by one or more processor direct the system to perform the methods and processes described herein. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system (and executable by a processing system/one or more processors) and encoding a computer program of instructions for executing a computer process. It should be understood that as used herein, in no case do the terms “storage media,” “computer-readable storage media” or “computer-readable storage medium” consist of transitory carrier waves or propagating signals. Instead, “storage” media refers to non-transitory media.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
receiving transaction data, the transaction data comprising at least two transaction attributes;
segmenting the transaction data based on a particular insight option of a plurality of insight options;
determining a resulting insight for the particular insight option based on the segmented transaction data;
storing the resulting insight in a storage resource;
receiving a request to access a particular type of insight via an insights API;
obtaining corresponding insights for the particular type of insight from the storage resource; and
sending the corresponding insights for the particular type of insight to a source of the request.

2. The method of claim 1, wherein the at least two transaction attributes comprise a merchant identifier, a masked user identifier, a time and date, a payment method, a country code of an issuer, a country code of the merchant, a state code of the merchant, a city code of the merchant, or a category code of the merchant.

3. The method of claim 1, wherein determining the resulting insight for the particular insight option based on the segmented transaction data comprises performing at least one of inferential analysis, cross-segment analysis, descriptive analysis, or user analysis on the segmented transaction data.

4. The method of claim 1, wherein the at least two transaction attributes comprise a merchant identifier and a masked user identifier,
wherein the resulting insight for the particular insight option comprises a frequency of returning customers for each merchant and a frequency of new customers for that merchant.

5. The method of claim 1, wherein the at least two transaction attributes comprise a merchant identifier, a masked user identifier, and at least one of a country code of an issuer, a country code of the merchant, a state code of the merchant, or a city code of the merchant,
wherein the resulting insight for the particular insight option comprises a location-based community of customers for each merchant.

6. The method of claim 1, wherein the at least two transaction attributes comprise a merchant identifier and a payment method,
wherein the resulting insight for the particular insight option comprises accepted methods of payment at each merchant.

7. The method of claim 1, wherein the at least two transaction attributes comprise a merchant identifier and a time and date,
wherein the resulting insight for the particular insight option comprises an operational status of each merchant.

8. A computer-readable storage medium having instructions stored thereon that when executed by a computing system, direct the computing system to at least:
receive transaction data, the transaction data comprising at least two transaction attributes;
segment the transaction data based on a particular insight option of a plurality of insight options;
determine a resulting insight for the particular insight option based on the segmented transaction data;
store the resulting insight in a storage resource; and
provide an insights API.

9. The medium of claim 8, wherein the instructions to provide the insights API direct the computing system to:
in response to receiving a request to access a particular type of insight via an insights API, obtain corresponding insights for the particular type of insight from the storage resource; and send the corresponding insights for the particular type of insight to a source of the request.

10. The medium of claim 9, wherein the particular type of insight comprises at least one of a frequency of returning customers, a frequency of new customers, a community of customers, whether a merchant is popular with tourists or locals, a payment method being used by customers at a merchant, or an operational status of a merchant.

11. The medium of claim 9, wherein the request to access the particular type of insight comprises a merchant identifier.

12. The medium of claim 8, wherein the instructions to provide the insights API direct the computing system to:
in response to receiving a request for a particular type of insight:
obtain the transaction data, segment the transaction data based on the particular insight option, wherein the particular insight option corresponds to the particular type of insight;
determine the resulting insight; and
send the resulting insight to a source of the request.

13. The medium of claim 12, wherein the request to access the particular type of insight comprises a merchant identifier.

14. The medium of claim 12, wherein the particular type of insight comprises at least one of a frequency of returning customers, a frequency of new customers, a community of customers, whether a merchant is popular with tourists or locals, a payment method being used by customers at a merchant, or an operational status of a merchant.

15. The medium of claim 8, wherein the at least two transaction attributes comprise a merchant identifier, a masked user identifier, a time and date, a payment method, a country code of an issuer, a country code of the merchant, a state code of the merchant, a city code of the merchant, or a category code of the merchant.

16. The medium of claim 8, wherein the instructions to determine the resulting insight direct the computing system to:
perform at least one of inferential analysis, cross-segment analysis, descriptive analysis, or user analysis on the segmented transaction data.

17. The medium of claim 8, further comprising instructions that direct the computing system to:
provide a push service configured to identify one or more recipients of a particular type of insight; and send, to each identified recipient of the one or more recipients, corresponding insights for the particular type of insight.

18. A system comprising:
a storage resource for storing insights;
an analysis engine operably coupled to a transaction resource and configured to:
receive transaction data, the transaction data comprising at least two transaction attributes;
segment the transaction data based on a particular insight option of a plurality of insight options;
determine a resulting insight for the particular insight option based on the segmented transaction data; and
an insight access module configured to manage and provide access to the insights stored in the storage resource, the insight access module supporting an insights application programming interface (API) or a push service.

19. The system of claim 18, wherein the at least two transaction attributes comprise a merchant identifier, a masked user identifier, a time and date, a payment method, a country code of an issuer, a country code of the merchant, a state code of the merchant, a city code of the merchant, or a category code of the merchant.

20. The system of claim 18, wherein the analysis engine is configured to determine the resulting insight by performing at least one of inferential analysis, cross-segment analysis, descriptive analysis, or user analysis.
